(19) United States
(12) Patent Application Publication
(10) Pub. No.: US 2024/0114598 A1
(43) Pub. Date: Apr. 4, 2024

(54) DIRECT ELECTRICAL HEATING OF PROCESS HEATER TUBES USING GALVANIC ISOLATION TECHNIQUES

(71) Applicant: Eurotherm Automation SAS, Dardilly (FR)

(72) Inventor: Grégoire QUERE, Lyon (FR)

(73) Assignee: Eurotherm Automation SAS, Dardilly (FR)

(21) Appl. No.: 18/478,719

(22) Filed: Sep. 29, 2023

(30) Foreign Application Priority Data
Sep. 29, 2022 (FR) 2209906

(51) Int. Cl. H05B 3/42; B01J 19/00; B01J 19/24; H05B 1/02

(52) U.S. Cl. CPC H05B 3/42; B01J 19/0013; B01J 19/2415; H05B 1/0244; H05B 2203/005

(57) ABSTRACT

The present disclosure is directed to systems and methods for direct electrical heating of a fluid conduit, also referred to in one form as a tube. A fluid heating system includes a tube defining a fluid passage. The tube includes a material having a conductivity greater than 1.0 Siemens per meter (S/m) at 20° Celsius. The material is distributed along the tube and the fluid passage defines an inlet configured to receive fluid and an outlet configured to release the fluid. The system includes a first power supply, which includes a first circuit. The first circuit is configured to conduct first electric current across a first portion of the tube and the first circuit includes a first galvanic isolator between a source of the first power supply and the first portion of the tube. The first power supply is configured to heat the tube based on the first electric current.

### CROSS REFERENCE TO RELATED APPLICATIONS

This application claims priority to and the benefit of Application No. 2209906 filed on Sep. 29, 2022, with the French (FR) Institut National de la Propriété Industrielle. The contents of this application are incorporated herein by reference in their entirety.

### FIELD

The present disclosure relates to a method and system for direct electrical heating of a fluid system.

### BACKGROUND

Traditional heating of heater tubes (e.g., reactor tubes) typically comprises fired heating. Fired heaters are subject to typical wear and tear which will ultimately lead to deterioration in the fired heater energy efficiency.

However, a problem exists when the electrical heating system is not properly insulated or when the system is insulated in such a way as to negatively impact the energy efficiency. For example, where each tube is required to be electrically insulated from the rest of the system, such as the other tubes, the tube inlet header, and/or the tube outlet header.

### SUMMARY

This section provides a general summary of the disclosure and is not a comprehensive disclosure of its full scope or all of its features.

The present disclosure is directed to a method of heating a thermal system, such as by way of example, a reactor system including a plurality of reactor tubes, each of the plurality of reactor tubes having a catalyst disposed therein and having at least one electrically conductive surface. The method comprises galvanically isolating the plurality of reactor tubes such that each of the plurality of reactor tubes can be directly welded to tube inlet and outlet headers of the reactor system; providing electrical energy to the at least one electrically conductive surface of each of the plurality of reactor tubes; and individually adjusting a current level of the electrical energy provided to the at least one electrically conductive surface of each reactor tube of the plurality of reactor tubes to individually control the temperature of each reactor tube of the plurality of reactor tubes and the catalyst disposed therein.

Direct electrical heating of heater tubes is one alternative to such a fired heating system. In a direct electrical heating system, the individual tubes are used as the heating medium and are directly heated using electrical current. Systems and methods for direct electrical heating of process heater tubes are provided wherein the tubes are galvanically isolated in such a manner as to reduce, or altogether remove, the use of electrical insulation of the tube from the rest of the system, such as the other tubes, the tube inlet header, and/or the tube outlet header.

The present disclosure is also directed to a method of heating a reactor system including a plurality of reactor tubes, each of the plurality of reactor tubes having a catalyst disposed therein and having at least one electrically conductive surface, wherein the plurality of reactor tubes are galvanically isolated in such a manner as to reduce, or altogether remove, the use of electrical insulation of each of the plurality of reactor tubes from the rest of the reactor system, such as other tubes of the plurality of reactor tubes, the tube inlet header, and/or the tube outlet header.

The present disclosure is further directed to a method of heating a reactor system including a plurality of reactor tubes, each of the plurality of reactor tubes having a catalyst disposed therein and having at least one electrically conductive surface, wherein the plurality of reactor tubes are galvanically isolated using a plurality of power controllers, the plurality of power controllers mirroring each other in order to move from zero volts at the inlet header to zero volts at the outlet header.

The present disclosure includes a fluid heating system. The fluid heating system includes a tube defining a fluid passage. The tube includes a material having a conductivity greater than 1.0 Siemens per meter (S/m) at 20° Celsius. The material is distributed along the tube and the fluid passage defines an inlet configured to receive fluid and an outlet configured to release the fluid.

In one or more forms, the fluid heating system includes a first power supply comprising a first circuit. The first circuit is configured to conduct first electric current across a first portion of the tube. The first circuit comprises a first galvanic isolator between a source of the first power supply and the first portion of the tube. The first power supply is configured to heat the tube based on the first electric current. In one or more forms, a second power supply comprises a second circuit. The second circuit is configured to conduct second electric current across a second portion of the tube. The second circuit comprises a second galvanic isolator between a source of the second power supply and the second portion of the tube. The second power supply is configured to heat the tube based on the second electric current. Further, a voltage of the first power supply and a voltage of the second power supply are substantially similar and a voltage across the first portion and the second portion is substantially zero.

In one or more forms, the voltage of the first power supply is a peak voltage of the first power supply and the first electric current is alternating. In one or more forms, the voltage of the second power supply is a peak voltage of the second power supply and the second electric current is alternating.

In one or more forms, the fluid heating system comprises a third power supply comprising a third circuit. The third circuit is configured to conduct third electric current across a third portion of the tube. The third circuit comprises a third galvanic isolator between a source of the third power supply and the third portion of the tube. In one or more forms, the third power supply is configured to heat the tube based on the third electric current. In one or more forms, a peak voltage of the third power supply is substantially similar to the peak voltage of the first power supply and the peak voltage of the second power supply, and the voltage over time across the first portion, the second portion, and the third portion is substantially zero.

In one or more forms, the first portion, the second portion, and the third portion comprise the material. In one or more forms, a phase of the first electric current is 120° from a phase of the second electric current and the phase of the first electric current is 240° from a phase of the third electric current. In one or more forms, the first galvanic isolator is a first transformer, the second galvanic isolator is a second transformer, and the third galvanic isolator is a third transformer. In one or more forms, the first portion extends to an end of the first portion located at a first location on the tube and the second portion extends to a first end of the second portion located at the first location and the second portion extends to a second end of the second portion located at a second location on the tube and the third portion extends to an end of the third portion located at the second location.

In one or more forms, a guide pin comprises a portion of the guide pin. The guide pin is configured to arrange the tube with respect to an enclosure and the first circuit comprises the portion of the guide pin. In one or more forms, the second circuit comprises the portion of the guide pin. In one or more forms, the portion of the guide pin has the conductivity. In one or more forms, the fluid heating system comprises a first manifold configured to provide matter and the tube is joined with the first manifold and the conductivity exists between the tube and the first manifold, the matter comprising the fluid.

In one or more forms, the fluid heating system comprises a second manifold configured to release the matter and the tube is joined with the second manifold and the conductivity exists between the tube and the second manifold. In one or more forms, a wire is disposed between the first manifold and the second manifold, and the wire has the conductivity and a voltage across the wire is substantially zero.

One or more forms of the present disclosure includes a method of heating a reactor system. The reactor system includes a plurality of reactor tubes. One of the plurality of reactor tubes has a catalyst disposed therein and the one of the plurality of reactor tubes comprises material having a conductivity greater than 1.0 Siemens per meter (S/m) at 20° Celsius. The reactor system comprises a first power supply comprising a first circuit configured to conduct first electric current across the material, and the first circuit comprises a galvanic isolator between the first power supply and the material. The method comprises providing the first electric current to the material. The method comprises adjusting a magnitude of the first electric current to control a temperature of the one of the plurality of reactor tubes and the catalyst disposed therein.

In one or more forms, the reactor system comprises a first manifold. The one of the plurality of reactor tubes is joined with the first manifold and the conductivity exists between the one of the plurality of reactor tubes and the first manifold. In one or more forms, the method further comprises providing fluid to the one of the plurality of reactor tubes with the first manifold. In one or more forms, the reactor system comprises a second manifold. The one of the plurality of reactor tubes is joined with the second manifold and the conductivity exists between the one of the plurality of reactor tubes and the second manifold. In one or more forms, the method includes releasing the fluid from the one of the plurality of reactor tubes with the second manifold. In one or more forms, a voltage between the first manifold and the second manifold is substantially zero based on the adjustment of the first electric current.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 illustrates a system in accordance with one or more implementations of the present disclosure;

FIG. 2 illustrates a multiphase system in accordance with one or more implementations of the present disclosure;

FIG. 3 illustrates a guide pin in accordance with one or more implementations of the present disclosure; and

FIG. 4 illustrates a method in accordance with one or more implementations of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

According to the teachings of the present disclosure, fire (or natural gas) heating of tubes is replaced with direct electric energy in which electrical energy is applied directly to the tube, which is made of a conductive material such as stainless steel, by way of example. Each tube can be equipped with its own electrical power system for heating, and the current to the tube can be adjusted to control the temperature of a fluid inside the tube. However, when using direct electric energy, each tube is to be electrically isolated from other tubes and from a main power source connected to each power system for each of the tubes.

The systems and methods provided by the present disclosure are directed to the direct heating of heater tubes using electrical current, with the tube or tubes being used as the heating medium.

In the present disclosure, the tube(s) are galvanically isolated in such a manner as to reduce, or altogether remove, the necessity of electrical insulation of the tube(s) from the rest of the system, such as other tube(s), the tube inlet header, and/or the tube outlet header.

Without galvanic isolation, tube(s) are generally required to be individually electrically insulated using a flange and gasket arrangement. With galvanic isolation, the requirement or quantity flanges and gaskets is reduced and the tubes can be directly connected (e.g., welded) to the inlet and outlet headers. This has the added benefit of making the system safer with respect to potential fluid leakages, reducing maintenance costs, and reducing downtime and capital costs. The system of the present disclosure also mitigates the risks of electrical hazards to personnel.

In certain forms, the present disclosure is directed to galvanic isolation of a system utilizing alternating current.

In various forms, the present disclosure is directed to a system utilizing low voltage. For example, less than about 50 Volts peak.

In some forms, the present disclosure is directed to a system utilizing a hybrid heat input control. For example, a system utilizing both fuel fired heating and electrical heating (e.g., direct electrical heating).

In one or more forms, the systems and processes of the present disclosure are equally applicable to single and multi-phase (e.g., three phase) electrical current heating arrangements.

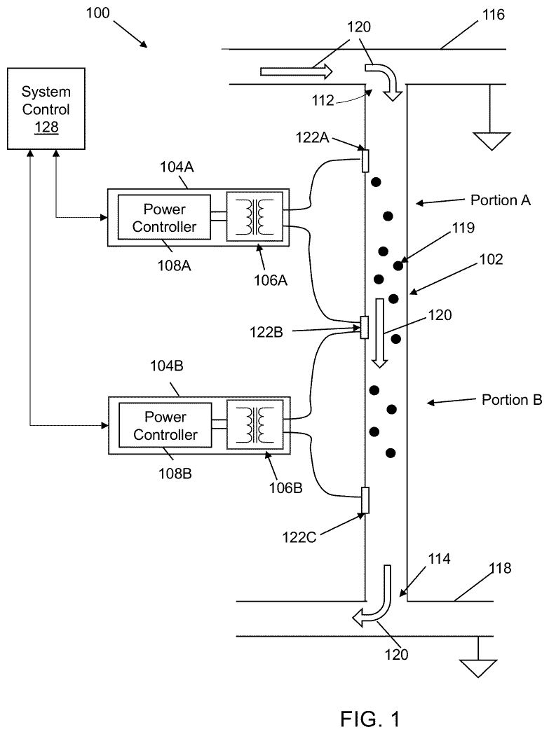

In FIG. 1, a system 100 is shown in accordance with one or more implementations of the present disclosure. System 100 includes a plurality of tubes, which includes tube 102 and a plurality of power systems 104A, 104B configured to heat fluid flowing within and through one or more of the tubes (e.g., tube 102). For clarity, only one tube 102 is shown and system 100 may include additional tubes connected with manifolds 116, 118. The tube 102 is composed of at least one material. For example, the tube 102 may comprise a conductive material (e.g., a material having a conductivity greater than 1.0 Siemen per meter (S/m) at 20° Celsius). The conductive material may be distributed throughout the tube. The material may be distributed along a length of the tube. The material may form a wire or circuit portion integral with the tube. The tube 102 is selected from the plurality of tubes for heating. The selection may be part of instructions executed by system control 128.

Selected tube 102 is electrically connected to power supplies 104A, 104B from among the plurality of power systems 104A, 104B. Generally, fluid flows through the tube 102, and the power systems 104A, 104B apply electric energy to the tube 102 to heat the fluid therein over respective portions. The set of power systems 104 form a thermal control system to control a temperature or more specifically, a thermal profile, of the tube 102 for heating the fluid. Together, the tube 102 and the set of power systems 104 form a heater subsystem, where the fluid heating system 100 includes a plurality of the heater subsystems. As described herein, the plurality of the heater subsystems are electrically isolated from each other, at least, by galvanically isolated power supplies and by providing a substantially zero sum voltage between opposite ends of the tube 102, as described in greater detail below.

In one form, the tube 102 defines a fluid passage and comprises electrically conductive material. The tube 102 further defines an inlet 112 connected to a fluid input manifold 116 (e.g., a first manifold) and an outlet 114 connected to a fluid output manifold 118 (e.g., a second manifold) to receive and expel the fluid. In one form, the manifolds 116 and 118 are electrically grounded. For purposes of clarity, only one tube 102 is illustrated, but it should be readily understood that multiple tubes 102 may be connected to the same fluid input manifold 116 and the fluid output manifold 118 while remaining within the scope of the present disclosure.

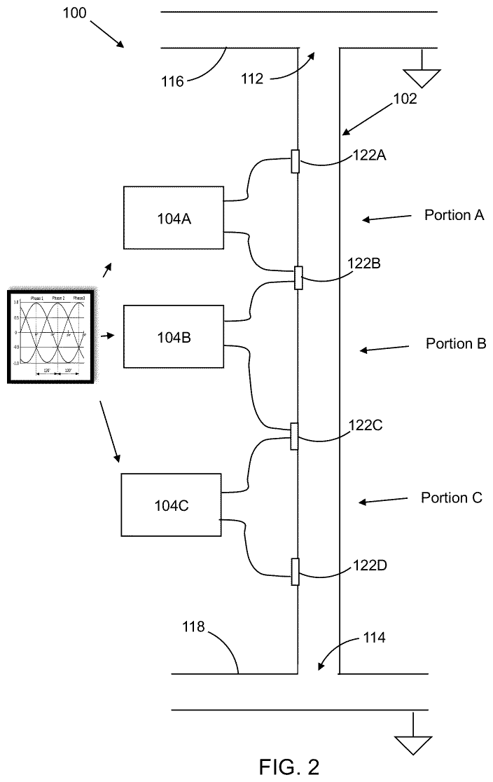

In an example application, the fluid heating system 100 is provided for a reactor system that employs a catalyst 119 to produce a chemical reaction within the tubes 102 when being heated by the electrical energy. Fluid enters the tube 102 through the fluid input manifold 116 and a byproduct of the chemical reaction is expelled or released via the fluid output manifold 118. The direction of the fluid and byproduct are provided with arrows 120 in FIG. 2. While the fluid heating system 100 having the tubes 102 and the power supplies 104A, 104B is described with respect to a reactor system, the fluid heating system 100 of the present disclosure may be provided with other fluid heating applications, both with and without chemical reactions, and should not be limited to a reactor system as illustrated and described herein. For example, the fluid heating system 100 may be provided for a reactor system not employing a catalyst. In another example, the system 100 is employed for heating water within the tube 102 to generate steam. Accordingly, the fluid heating system 100 can be used for other suitable applications in which direct electrical energy as illustrated and described herein is employed to heat tubes, and thus the fluid flowing within the tubes.

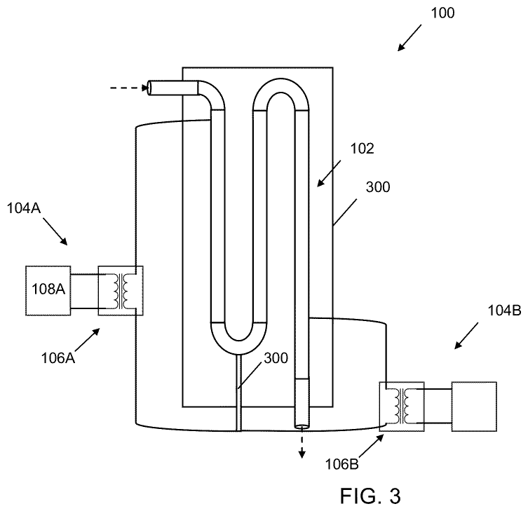

In one form, the plurality of power systems are configured to provide high electric current (e.g., 1,000-10,000 Amps) directly to the tubes 102 and, as described herein, the electric current is controlled between at least two low voltage terminals or cold terminals of the set of power supplies 104A, 104B connected to the selected tube 102. The power supplies 104A, 104B are electrically connected to terminals 122 of the tube 102 (e.g., terminals 122A, 122B, 122C) to apply electrical energy at the respective portions of the tube 102. Each power supply 104A, 104B includes a galvanic isolator (G-I) 106A, 106B and a power controller 108A, 108B for controlling the power supplies 104A, 104B. The power controllers 108A, 108B provide power to a source (e.g., a source side winding) of the galvanic isolator, which is galvanically isolated from the output side of the galvanic isolator which comprises a circuit between the tube 102 and terminals of the output side of the galvanic isolator. In one form, if the set of power systems 104 includes two or more power systems 104, the set of power systems 104 defines a plurality of portions of the tube 102, where each power supply 104A, 104B provides electrical energy at a respective portion. For example, the power supply 104A defines portion A generally between terminals 122A and 122B and the power supply 104B defines zone B generally between terminals 122B and 122C. While FIG. 2 illustrates two power supplies 104A, 104B more power supplies are contemplated as shown in FIG. 3.

The power controllers 108A, 108B are configured to operate the power supplies 104A, 104B to provide the electric energy to the tube 102. More specifically, power controllers 108A, 108B are configured to control a temperature of respective portions of the tube 102 by adjusting an electric current to be provided by the power supplies 104A, 104B based on one or more operational parameters. As detailed below, the power controllers 108A, 108B of the set of power supplies 104A, 104B are configured to effectively cancel corresponding voltages applied across respective portions such that zero voltage is provided between the manifolds 116, 118 and to reduce the amount of electric current traveling to ground. In one form, the power controllers 108A, 108B include a power converter to adjust the power from the power source to a desired level (e.g., desired voltage and/or desired current). The power controllers 108A, 108B may implement switches (e.g., Power Field Effect Transistors) to control the output voltage, current, phase, or other parameters of the power provided to tube 102. The power controllers 108A, 108B may also include other circuitry such as a communication interface and/or a power safety switch (not shown). The communication interface is configured to communicate with external devices such a system controller 128 that provides an operational signal indicative of the amount of electric energy (i.e., power, voltage, and/or current) to be provided to the tube 102 by the power supplies 104A, 104B. A power safety switch may be configured to turn power OFF to the power supplies 104A, 104B in response to an electrical characteristic being at or above a desired threshold.

As shown, the power supplies 104A, 104B are electrically connected to respective portions of the tube 102 to provide the electric energy to heat the tube 102. The galvanic isolators 106A, 106B may be transforms, as schematically shown. The galvanic isolators 106A, 106B are configured to receive adjustable power from respective power controllers 108A, 108B. The galvanic isolators 106A, 106B convey alternating current to the tube 102 while isolating direct current from transfer to the tube. Thus, the power supplies 104A, 104B are operable to provide a vast range of voltage and/or electric current (e.g., alternating current).

In one form, during operation, the system controller 128 processes the operational parameters to determine the amount of energy to be provided to each tube 102. The system controller 128 may be configured in various suitable ways for determining the current to be applied by the power supplies 104A, 104B and provide the operational signals to the set of power supplies 104A, 104B. For example, the system controller 128 is configured to include a closed-loop control routine defined to determine the amount of electric current to apply based on one or more operational setpoints such as, but not limited to, temperature setpoint, voltage setpoint, current setpoint, and/or power setpoint. In another example, the system controller 128 is configured to include an open-loop control routine to provide a desired amount of current for a period of time. It should be readily understood that other control routines may be employed for the system controller 128, and the system controller 128 should not be limited to the examples provided herein. In one form, the system controller 128 may be part of the thermal control system to control the power systems 104. That is, in some applications, the power supplies 104A, 104B of the present disclosure may be employed with a preexisting system controller. In other applications, the system controller 128 may be provided with the power supplies 104A, 104B.

To control the amount of electric current flowing to ground, the set of power supplies 104A, 104B electrically connected to the tube 102 is configured to provide substantially zero voltage to ground. More particularly, in the example of FIG. 2, the voltage provided by the power supply 104B to the tube 102 is of substantially the same opposite voltage as the voltage provided by power supply 104A. Specifically, the galvanic isolator 106A is electrically connected at the portion 122A and the portion 122B of the tube 102 to form a circuit or portion thereof with the tube 102, and the galvanic isolator 106B is electrically connected at the portion 122B and the portion 122C of the tube 102 to form a circuit or portion thereof with the tube 102. One connection from the galvanic isolator 106A (e.g., at terminal 122B) may be connected with a connection from the galvanic isolator 106B (e.g., at terminal 122B).

Referring to FIG. 2, a system 100 having multiple phases is shown in accordance with one or more implementations of the present disclosure. For example, power supplies 104A, 104B may not be required to provide strictly mirrored voltage to obtain substantially zero voltage between the manifolds 116, 118. For example, three-phase power may be provided to tube 102 such that the net voltage between manifolds, or outermost terminals, 116, 118 is zero. Additional phases are contemplated by this disclosure. Fewer phases are contemplated by this disclosure. FIG. 3 illustrates the tube 102 and the set of power supplies 104A, 104B of FIG. 2, and further includes an additional power supply 104C connected to the tube 102. Power supply 104C may be similarly configured with a galvanic isolator. The power supplies 104A, 104B, 104C are connected such that: the power system 104A is electrically connected to terminals 122A and 122B of the tube 102 defining portion A; the power system 104B is electrically connected to terminals 122B and 122C defining portion B; and the power system 104C is electrically connected to terminals 122C and 122D defining portion C. The terminals 122A and 122D are closest to the inlet 112 and the outlet 114 of tube 102, respectively, and thus the power supplies 104A, 104B, 104C are connected to tube 102 such that the voltage between manifolds 116, 118 is substantially zero when power supplies 104A, 104B, 104C each provide one phase of a three-phase source. For example, a three-phase power source may be provided with one phase provided to each of the power supplies 104A, 104B, 104C. As such, when a voltage associated with phase A, of power supply 104A, is at its peak, the negative voltages from phases B and C, of power supplies 104B, 104C, are equally opposite, ensure that the voltage between terminals 122A, 122D, and manifolds 116, 118, is substantially zero.

In one form, the placement of the high voltage terminal(s) of the G-I power supply 106 is selected to provide a desired thermal profile for the application employing the fluid heating system 100, and may be determined based on various parameters, such as but not limited to, a concentration of the catalyst and/or cold spots along the tube 102. For example, in the example application of FIG. 2, if the catalyst 119 is concentrated closer to the fluid output manifold 118, the hot terminals may be connected to a portion of the tube 102 closer to the portion 122C to concentrate the electric energy, and thus, the heat generated near the concentrated catalyst. It should be understood herein that any location that has a voltage different from ground, may be positive or negative.

In a multi-phase electrical current heating arrangement, multiple power controllers may be utilized that minor each other in order to move from 0 volt at the inlet to 0 volt at the outlet. For example, in one form, a plurality of reactor tubes are galvanically isolated using a plurality of power controllers, the plurality of power controllers mirroring each other in order to move from zero volts at the inlet header to zero volts at the outlet header. This allows the system to be referred to as “zero volt.”

In another form, a multi-phase electrical current heating arrangement comprises multiple power controllers that minor each other in order to move from 0 volt at the inlet to 0 volt at the outlet of a single reactor tube. This configuration allows for the creating of multiple heating zones within a single reactor tube.

The galvanically isolated controller can also be arranged in a way that the inlet and the outlet is “earthed” (zero volt), with minimal earthing grounding current (i.e., to control the earth current). Each of these above alternative forms is achievable utilizing the galvanic isolation described herein.

Referring to FIG. 3, a guide pin 302 is shown in accordance with one or more implementations of the present disclosure. The tube 102, as apart of system 100, may follow an indirect path between manifolds 116, 118, as shown. The tube 102 may be supported by a guide pin 302 to arrange the tube 102 within an enclosure or housing. For example, the power supplies 104A, 104B may similarly provide heating with terminals on the tube 102 and the guide pin 302 to heat the tube 102 and catalysts disposed therein.

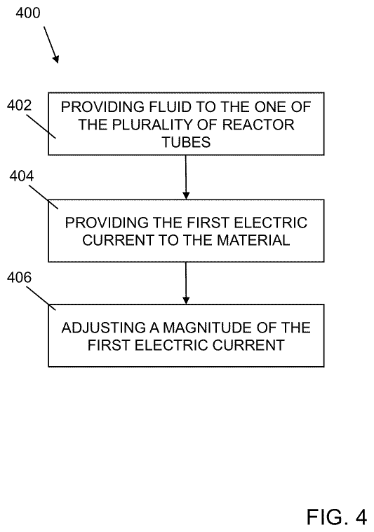

Referring to FIG. 4, a method 400 is shown in accordance with one or more implementation of the present disclosure. The method 400 may be performed in accordance with the systems (e.g., system 100) described herein or other systems. The method 400 may include providing fluid (e.g., liquid or gaseous matter) to one or more of the tubes 102 in step 402. The fluid may be provided by a manifold (e.g., manifold 116) and the fluid may be release by a manifold (e.g., manifold 118). The method 400 may include a step for releasing the fluid. In step 404, electric current may be provided to the tube 102 for heating the matter therein (e.g., a catalyst). The electric current may be provided to a conductive material to generate resistive heating. For example, the tube 102 may comprise material have properties that enable heating of the fluid. In step 406, the electric current may be adjusted (e.g., by controller 108A, 108B) to alter the magnitude of heat applied to the fluid by tube 102. The steps of method 404 may be performed by a computer or controller comprising a processor and memory. For example, the memory may store instructions executable by a processor or controller to cause performance of the steps listed herein.

Having described various forms of the present disclosure in detail, it will be apparent that modifications and variations are possible without departing from the scope of the present disclosure, such as those defined in the appended claims.

When introducing elements of the present disclosure or various forms(s) thereof, the articles “a”, “an”, “the” and “said” are intended to mean that there are one or more of the elements. The terms “comprising”, “including” and “having” are intended to be inclusive and mean that there may be additional elements other than the listed elements.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

As various changes could be made in the above system, processes, and reaction, without departing from the scope of the present disclosure, it is intended that all matter contained in the above description and shown in the accompanying drawings shall be interpreted as illustrative and not in a limiting sense.

What is claimed is:

1. A method of heating a reactor system including a plurality of reactor tubes, each of the plurality of reactor tubes having a catalyst disposed therein and having at least one electrically conductive surface, the method comprising:
galvanically isolating the plurality of reactor tubes such that each of the plurality of reactor tubes can be directly welded to tube inlet and outlet headers of the reactor system;
providing electrical energy to the at least one electrically conductive surface of each of the plurality of reactor tubes; and
individually adjusting a current level of the electrical energy provided to the at least one electrically conductive surface of each reactor tube of the plurality of reactor tubes to individually control the temperature of each reactor tube of the plurality of reactor tubes and the catalyst disposed therein.

2. The method of claim 1, wherein the plurality of reactor tubes are galvanically isolated in such a manner as to avoid the use of electrical insulation of each of the plurality of reactor tubes from the rest of the reactor system.

3. The method of claim 1, wherein the plurality of reactor tubes are galvanically isolated using a plurality of power controllers, the plurality of power controllers mirroring each other in order to move from zero volts at the inlet header to zero volts at the outlet header.

4. A fluid heating system comprising:
a tube defining a fluid passage, the tube comprising a material having a conductivity greater than 1.0 Siemens per meter (S/m) at 20° Celsius, the material distributed along the tube, wherein the fluid passage defines an inlet configured to receive fluid and an outlet configured to release the fluid;
a first power supply comprising a first circuit, the first circuit configured to conduct first electric current across a first portion of the tube, the first circuit comprising a first galvanic isolation between a source of the first power supply and the first portion of the tube, wherein the first power supply is configured to heat the tube based on the first electric current; and
a second power supply comprising a second circuit, the second circuit configured to conduct second electric current across a second portion of the tube, the second circuit comprising a second galvanic isolation between a source of the second power supply and the second portion of the tube, wherein the second power supply is configured to heat the tube based on the second electric current and wherein a voltage of the first power supply and a voltage of the second power supply are substantially similar and a voltage across the first portion and the second portion is substantially zero.

5. The fluid heating system of claim 4, wherein the voltage of the first power supply is a peak voltage of the first power supply and the first electric current is alternating and wherein the voltage of the second power supply is a peak voltage of the second power supply and the second electric current is alternating.

6. The fluid heating system of claim 5, further comprising:
a third power supply comprising a third circuit, the third circuit configured to conduct third electric current across a third portion of the tube, the third circuit comprising a third galvanic isolation between a source of the third power supply and the third portion of the tube, wherein the third power supply is configured to heat the tube based on the third electric current and wherein a peak voltage of the third power supply is substantially similar to the peak voltage of the first power supply and the peak voltage of the second power supply and the voltage over time across the first portion, the second portion, and the third portion is substantially zero.

7. The fluid heating system of claim 6, wherein the first portion, the second portion, and the third portion comprise the material.

8. The fluid heating system of claim 6, wherein a phase of the first electric current is 120° from a phase of the second electric current and the phase of the first electric current is 240° from a phase of the third electric current.

9. The fluid heating system of claim 6, wherein the first galvanic isolation is based on a first transformer, the second galvanic isolator is based on a second transformer, and the third galvanic isolator is based on a third transformer.

10. The fluid heating system of claim 6, wherein the first portion extends to an end of the first portion located at a first location on the tube and the second portion extends to a first end of the second portion located at the first location and wherein the second portion extends to a second end of the second portion located at a second location on the tube and the third portion extends to an end of the third portion located at the second location.

11. The fluid heating system of claim 4, further comprising:
a guide pin comprising a portion of the guide pin, the guide pin configured to arrange the tube with respect to an enclosure and wherein the first circuit comprises the portion of the guide pin.

12. The fluid heating system of claim 11, wherein the second circuit comprises the portion of the guide pin.

13. The fluid heating system of claim 11, wherein the portion of the guide pin has the conductivity.

14. The fluid heating system of claim 4, wherein the fluid heating system comprises a first manifold configured to provide matter and wherein the tube is joined with the first manifold and the conductivity exists between the tube and the first manifold, the matter comprising the fluid.

15. The fluid heating system of claim 14, wherein the fluid heating system comprises a second manifold configured to release the matter and wherein the tube is joined with the second manifold and the conductivity exists between the tube and the second manifold.

16. The fluid heating system of claim 15, further comprising:
a wire between the first manifold and the second manifold, wherein the wire has the conductivity and a voltage across the wire is substantially zero.

17. A method of heating a reactor system including a plurality of reactor tubes, one of the plurality of reactor tubes having a catalyst disposed therein, the one of the plurality of reactor tubes comprising material having a conductivity greater than 1.0 Siemens per meter (S/m) at 20° Celsius, a first power supply comprising a first circuit configured to conduct first electric current across the material, the first circuit comprising a galvanic isolation between the first power supply and the material, the method comprising:
providing the first electric current to the material; and
adjusting a magnitude of the first electric current to control a temperature of the one of the plurality of reactor tubes and the catalyst disposed therein.

18. The method of claim 17, wherein the reactor system comprises a first manifold, wherein the one of the plurality of reactor tubes is joined with the first manifold and the conductivity exists between the one of the plurality of reactor tubes and the first manifold, the method further comprising:
providing fluid to the one of the plurality of reactor tubes with the first manifold.

19. The method of claim 18, wherein the reactor system comprises a second manifold, wherein the one of the plurality of reactor tubes is joined with the second manifold and the conductivity exists between the one of the plurality of reactor tubes and the second manifold, the method further comprising:
releasing the fluid from the one of the plurality of reactor tubes with the second manifold.

20. The method of claim 19, wherein a voltage between the first manifold and the second manifold is substantially zero based on the adjustment of the first electric current.
